(19) United States
(12) Patent Application Publication
(10) Pub. No.: US 2015/0066948 A1
(43) Pub. Date: Mar. 5, 2015

(54) Influence Scoring for Social Media Authors

(71) Applicant: Adobe Systems Incorporated, San Jose, CA (US)

(72) Inventors: Tyler W. Carlton, Highland, UT (US); Ryan E. Cobourn, Sandy, UT (US); Carmen Sutter, Salt Lake City, UT (US); Steven L. Wirig, Highland, UT (US)

(73) Assignee: Adobe Systems Incorporated, San Jose, CA (US)

(21) Appl. No.: 14/010,709

(22) Filed: Aug. 27, 2013

(51) Int. Cl. G06F 17/30; G06F 15/173

(52) U.S. Cl. CPC G06F 17/3053; G06F 15/17306
USPC 707/748

(57) ABSTRACT

Techniques for influence scoring for social media authors are described. Generally, an influence score indicates a relative level of influence that a particular social media author has in a social media environment, such as compared to other social media authors. According to various embodiments, events correlated to social media authors on different social media platforms are used to determine influence scores for the authors. To enable events that are correlated to social media authors to be quantified for purposes of determining influence, various metrics are defined that correspond to the events. An influence score for a social media author can be calculated using values for a group of metrics associated with the author.

### BACKGROUND

Social media platforms present an increasingly popular way for individuals to interact via the Internet. For instance, a user typically sets up an account that uniquely identifies the user on a particular social media platform. Using the account, the user may post various types of content, such as comments (e.g., “status updates”), photos, video, links to websites of interest, and so forth. Further, a user may have accounts with multiple different platforms, and can post content to the different platforms using the different accounts. For instance, a particular platform may be better suited for posting a specific type of content than another platform. Thus, a user's collection of accounts with different social media platforms represents the user's presence in an overall social media environment.

Social media not only provides a means for individuals to interact, it also provides an opportunity to gather various types of information about users. For instance, marketers can monitor social media platforms to determine user interest in various products, services, and so on. This enables marketers to focus promotions on users who may have interest in particular products or services that are being promoted. Due to the sheer amount of data available from different social platforms, however, determining preferences of specific users can be challenging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for influence scoring for social media authors are described. Generally, an influence score indicates a relative level of influence that a particular social media author has in a social media environment, such as compared to other social media authors. According to various embodiments, events correlated to social media authors on different social media platforms are used to determine influence scores for the authors. To enable events that are correlated to social media authors to be quantified for purposes of determining influence, various metrics are defined that correspond to the events. An influence score for a social media author can be calculated using values for a group of metrics associated with the author.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more embodiments.

FIG. 2 illustrates an example graphical user interface in accordance with one or more embodiments.

FIG. 3 illustrates an example graphical user interface in accordance with one or more embodiments.

FIG. 4 illustrates an example graphical user interface in accordance with one or more embodiments

FIG. 5 is a flow diagram that describes steps in a method in accordance with one or more embodiments.

FIG. 6 is a flow diagram that describes steps in a method in accordance with one or more embodiments.

FIG. 7 is a flow diagram that describes steps in a method in accordance with one or more embodiments.

FIG. 8 is a flow diagram that describes steps in a method in accordance with one or more embodiments.

FIG. 9 is a flow diagram that describes steps in a method in accordance with one or more embodiments.

FIG. 10 is a flow diagram that describes steps in a method in accordance with one or more embodiments.

FIG. 11 illustrates an example system and computing device as described with reference to FIG. 1, which are configured to implement embodiments of techniques described herein.

### DETAILED DESCRIPTION

Overview

Techniques for influence scoring for social media authors are described. Generally, an influence score indicates a relative level of influence that a particular social media author has in a social media environment, such as compared to other social media authors. Influence scores can be used by various entities to focus promotion efforts, such as for advertising, information gathering, information dissemination, and so forth.

According to various embodiments, events correlated to social media authors on different social media platforms are used to determine influence scores for the authors. Generally, a social media platform is a website and/or other network-based service that enables interaction between different users. For instance, users can post various types of content to a social media platform, such as text comments, photographs, video, hyperlinks to websites, and so forth. Other users can view the posted content and, in some situations, interact with the posted content.

To enable events that are correlated to social media authors to be quantified for purposes of determining influence, various metrics are defined that correspond to the events. For instance, a “Reach” metric corresponds to a number of users that have demonstrated an affinity for a particular social media author. The Reach metric, for example, can be quantified as a number of friends, fans, followers, and so forth, that a particular social media author has on different social media platforms.

Metrics can also be defined based on referrals from social media authors that cause other users to perform certain actions. For instance, a “Referred Visit” metric corresponds to a user visit to a website that resulted from a referral by a social media author. As an example, consider that a social media author posts a hyperlink to a website on one of their social media pages. When another user views the post and selects the hyperlink to navigate to the website, the social media author can be credited with a Referred Visit to the website. Thus, a value for the author's Referred Visit metric is increased, which increases the author's overall influence score. A variety of other social media events and metrics can be considered for determining influence, examples of which are discussed below.

Metrics can be assigned to a social media author in a variety of ways, such as by assigning an author to an author category that has a pre-defined set of metrics. A set of metrics can also be customized for a particular social media author, such as by customizing a set of metrics from an author category, and/or by creating a new set of metrics for an author. Based on a group of metrics associated with a social media author, an influence score for the social media author can be calculated. Metrics may also be weighted, such that a weighting value is applied to a metric value prior to using the metric value to calculate an influence score. This enables users to specify which metrics are more important than others in determining an influence score.

In the following discussion, an example environment is first described that is operable to employ techniques described herein. Next, a section entitled “Example Graphical User Interfaces” describes some graphical user interfaces for implementing aspects of techniques discussed. Following this, a section entitled “Example Procedures” describes some example methods for influence scoring for social media authors in accordance with one or more embodiments. Finally, a section entitled “Example System and Device” describes an example system and device that are operable to employ techniques discussed herein in accordance with one or more embodiments.

Example Environment

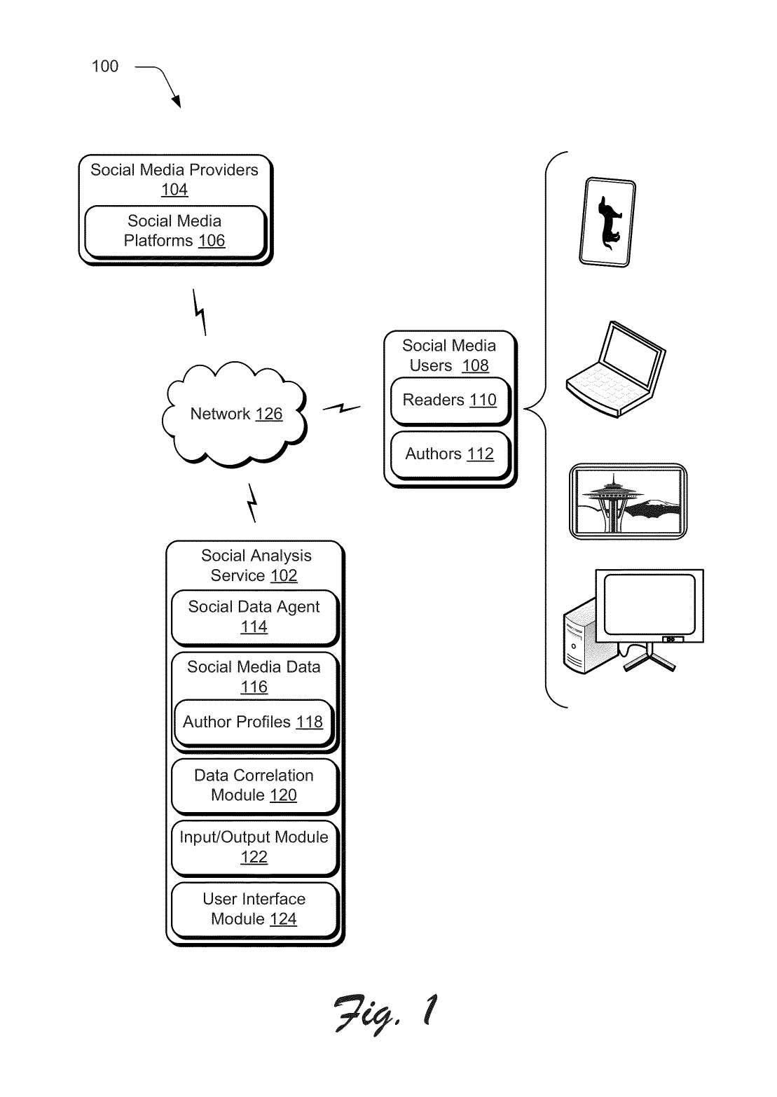

FIG. 1 is an illustration of an environment 100 in an example implementation that is operable to employ techniques for influence scoring for social media authors discussed herein. Environment 100 includes a social analysis service 102, which is representative functionality to process social media data, such as to perform various techniques discussed herein. The social analysis service 102 can be leveraged by various entities, such as advertisers, promoters, product developers, and so forth. The social analysis service 102 can be implemented in a variety of ways, such as a distributed application (e.g., a web app), a local application, and/or combinations thereof. Further, the social analysis service 102 can be implemented via various types and/or combinations of computing devices, examples of which are described below in FIG. 11.

The environment 100 further includes social media providers 104, which are representative of various enterprises and/or services that provide social media platforms 106 via which different users may interact and communicate. For instance, the social media platforms 106 can include web-based portals for social interaction. At least some of the social media platforms 106, for instance, can include webpages and/or web apps that enable users to view and post content.

Social media users 108 are illustrated, which are representative of users which may interact via the social media platforms 106. For instance, the social media users 108 create accounts with the different social media platforms 106. Utilizing the accounts, the social media users 108 can post various types of content to the social media platforms 106, such as text content (e.g., messages), photographs, video, audio, and so on. The social media users 108 can also utilize the social media platforms 106 to demonstrate an affinity for various content and/or entities, such as by indicating a preference (e.g., “liking”) for a particular instance of content, “friending” other users, following other users, and so on.

Included in the social media users 108 are two general categories of users, readers 110 and authors 112. The readers 110 are representative of users that primarily consume social media content, such as by visiting various of the social media platforms 106 to view content. The authors 112 are representative of users that post content to the social media platforms 106.

While it is the case that many of the social media users 108 will be both a reader 110 and an author 112, it is to be appreciated that some users are more prominently an author 112. For instance, celebrities, sports stars, technology companies, and so forth, often use social media platforms as a means of promotion. Such entities typically have many followers (e.g., readers 110) on the social media platforms 106 that consume posted content. Thus, such entities may be considered authors 112 for purposes of discussion herein. This is not intended to be limiting, however, and any user that posts content to the social media platforms 106 can be considered an author 112.

The social analysis service 102 includes various functionalities that are leveraged to perform techniques discussed herein. For instance, a social data agent 114 represents functionality to detect various social media events, and to collect social media data 116 for the social analysis service 102. For instance, the social media data 116 can be pulled by the social data agent 114 from the social media platforms 106, and/or pushed to the social data agent 114 by the social media platforms 106.

The social media data 112 can include various types of data, such as identifiers for the social media users 108, content posted to the social media platforms 106, geographic region identifiers associated with posted content, keywords extracted from posted content, keywords provided by users in advance, and so on. For instance, consider that one of the social media users 108 posts a comment via a smartphone to one of the social media platforms 106. The comment identifies (e.g., tags) a particular restaurant, and includes the phrase “Food here is excellent!” The social media data 110 extracted from the comment can include a name for the restaurant, geographic information for the restaurant (e.g., GPS coordinates), keywords extracted from the comment (e.g., “food,” “excellent”), and so forth.

The social media data 116 includes user profiles 118, which are representative of collections of information for the social media users 108. For instance, a particular user may have multiple social media accounts with the different social media platforms 106. According to various embodiments, the user profiles 118 can include an identifier for the user that correlates the multiple social media accounts to a single user. Various other types of data can be tracked via the user profiles 118, such as user preferences, user history (e.g., historic posts from the social media platforms 106), groups of other users known to interact with a particular user (e.g., “followers”), and so forth. As further detailed below, the user profiles 118 further include various scores, categorizations, and rankings for users, such as based on metrics specified for quantifying user-related conversions linked to social media interactions.

The social analysis service 102 includes various functionalities for managing and processing the social media data 116. For instance, a data correlation module 120 is included, which is representative of functionality to process the social media data 116 and identify various attributes of the social media data. For instance, the data correlation module 120 can parse the social media data 116 to identify keywords, sentiment information (e.g., likes/dislikes associated with different content and/or entities), geographical information (e.g., geographical coordinates for posts), and so on. The data correlation module 120 is further configured to apply various metrics to the social media data 116 to perform techniques for influence scoring for social media authors discussed herein. Further operations and implementation details of the data correlation module 120 are discussed below.

The social analysis service 102 further includes an input/output (I/O) module 122, which is representative of functionality to receive various types of input and provide various types of output. For instance, the I/O module 122 can receive user input to interact with the data correlation module 120, such as to configure various parameters for tracking and scoring the social media users 108 according to techniques discussed herein.

A user interface module 124 is further included, which is representative of functionality to manage various aspects of graphical user interfaces discussed herein. For instance, the user interface module 116 can operate in conjunction with the I/O module 122 to output various information related to the social media data 116 as processed by the data correlation module 120. The user interface module 124 may also provide interactive interfaces via which a user can provide input to configure various parameters and processes discussed herein, examples of which are discussed below.

The environment 100 further includes one or more networks 126 via which various entities of the environment 100 may communicate. The network(s) 126 may assume a variety of different configurations, such as a local area network (LAN), a wide area network (WAN), the Internet, and so on. In at least some embodiments, functionalities discussed with reference to the environment 100 and/or other portions of the discussion herein may be implemented in a distributed environment (e.g., “over the cloud”), as further described in relation to FIG. 11.

Having described an example environment in which the techniques described herein may operate, consider now a discussion of some example implementation scenarios in accordance with one or more embodiments.

Example Graphical User Interfaces

The following discussion describes example graphical user interfaces (GUIs) that can be employed to perform various aspects of techniques discussed herein in accordance with one or more embodiments. The example GUIs may be employed in the environment 100 of FIG. 1, the system 1100 of FIG. 11, and/or any other suitable environment.

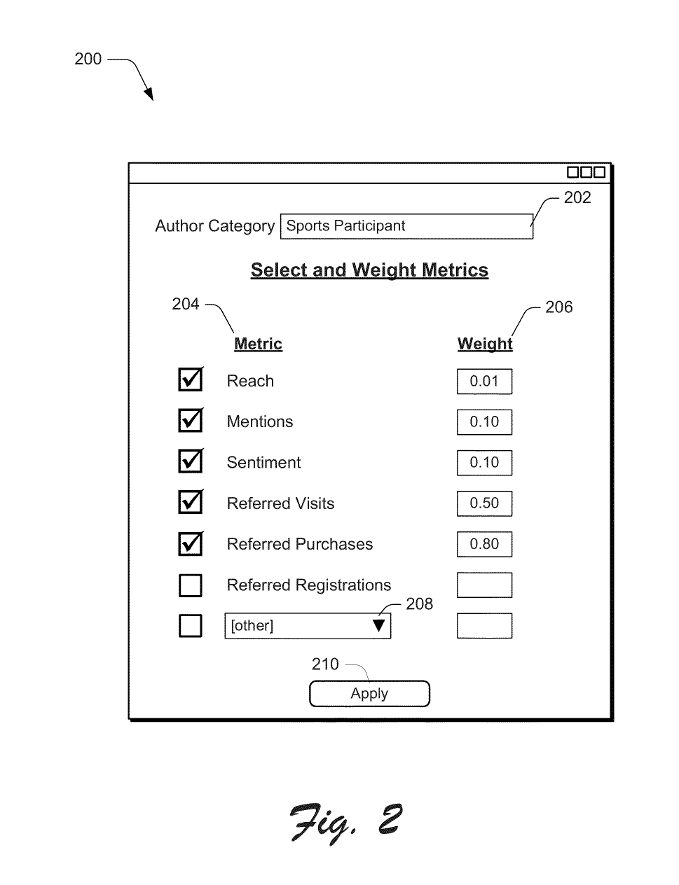

FIG. 2 illustrates an example graphical user interface (GUI) 200 that can be employed to configure scoring algorithms for generating influence scores for social media authors. The GUI 200 includes a variety of menus and/or fields that can receive user input to provide and configure scoring parameters.

For instance, the GUI 200 includes an author category field 202 in which a user can input a category identifier for categorizing different types of authors. An author, for example, can be placed in a particular author category based on the author's interests. Example ways of categorizing authors are discussed in detail below.

According to various embodiments, the author category field 202 can be used to define a new author category. Alternatively or additionally, the author category field 202 can be used to configure and/or re-configure a scoring algorithm for an existing author category. Although this particular example illustrates the author category field 202 as a fillable field, it is to be appreciated that embodiments may use different implementations. For instance, the author category field 202 can be implemented as a drop-down menu that presents different selectable author categories. In this particular example, a user inputs the author category “Sports Participant.”

The GUI 200 further includes a metric column 204 and a weight column 206. The metric column 204 lists a variety of different metrics that can be selected for generating an influence score for an author. Generally, a metric corresponds to an event that can be correlated to a social media author. The different metrics listed in the metric column 204 can be selected or unselected, such as via an associated checkbox.

The weight column 206 includes fillable fields that enable a user to specify a scoring weight for an associated metric from the metric column 204. For instance, a value entered into the weight column 206 can be applied to a raw metric value for a particular metric to obtain a weighted value, which contributes to a cumulative influence score for an author. The listed metrics are now briefly discussed.

Reach—this metric determines how many other social media users have shown an affinity and/or interest in a particular author. For example, “reach” can indicate a number of friends, fans, followers, and so forth, that a particular author has in their array of social media profiles.

Mentions—this metric refers to discrete instances when a particular author has been mentioned by other social media users, such as in comments made on a social media platform.

Sentiment—this metric measures sentiment values for an author, such as likes and/or other sentiment values specified by other users for an author.

Referred Visits—this metric looks at visits to particular websites that can be attributed to a referral from an author. For instance, when an author posts a link to a website on a social media platform, and another user follows the link to visit the website, this indicates a referred visit. A referred visit can be detected in a variety of other ways, however, such as via textual analysis of a comment indicating that a website visit was made based on a referral from an author.

Referred Purchases—this metric looks at purchases that can be attributed to referrals from an author. For instance, when a user visits a website based on a referral from an author (e.g., a “referred visit”) and subsequently purchases an item from the website, this indicates a referred purchase. A referred purchase can be detected in a variety of other ways, however, such as via textual analysis of a comment indicating that a purchase was made based on a referral from an author.

Referred Registrations—this metric looks at registrations that can be attributed to referrals from an author. For instance, when a user visits a website based on a referral from an author (e.g., a “referred visit”) and subsequently registers (e.g., creates a user account) with the website, this indicates a referred registration. A referred registration can be detected in a variety of other ways, however, such as via textual analysis of a comment indicating that a user registered with a website and/or other service based on a referral from an author.

The GUI 200 further includes an “other” metric 208, from which other metrics may be selected. For instance, the other metric 208 can include a drop-down menu with multiple different selectable metrics. The other metric 208 includes a weight field that can be used to specify a weight value for a selected metric. Thus, the example metrics listed in the GUI 200 are presented for purpose of example only, and a wide variety of different metrics can be employed according to techniques discussed herein.

Further illustrated is an apply control 210, which is selectable to apply the input provided to the GUI 200. For instance, selecting the apply control 210 generates an author category with selected metrics and metric weighting. In this particular example, a “Sports Participant” category is generated and/or configured with the selected metrics. The selected metrics include the reach metric with a weighting of 0.01, the mentions metric with a weighting of 0.10, the sentiment metric with a weighting of 0.10, the referred visits metric with a weighting of 0.50, and the referred purchases metric with a weighting of 0.80. Together, the metrics are utilized to determine a total influence score for an author that is placed in the Sports Participant category.

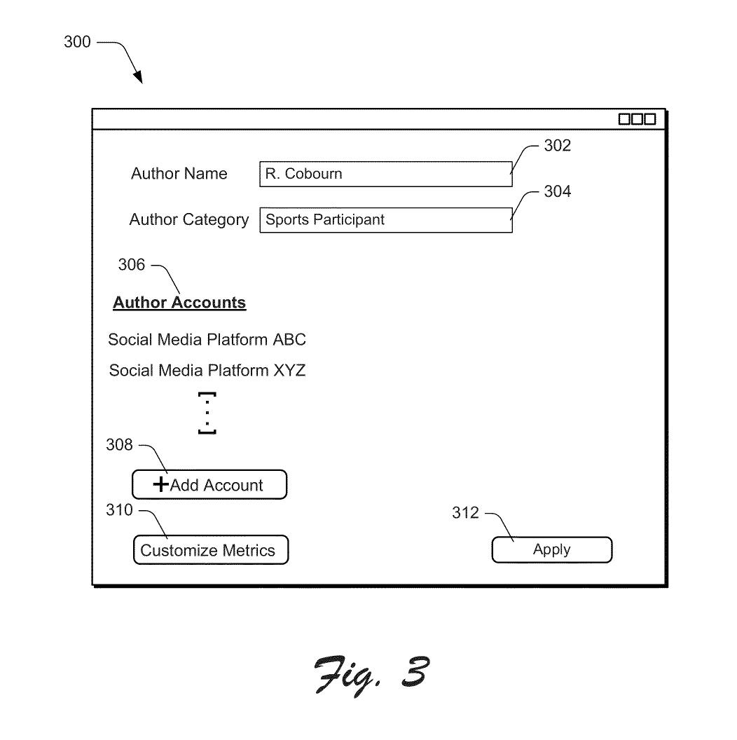

FIG. 3 illustrates an example graphical user interface (GUI) 300 that can be employed to configure author profiles for tracking social media information for different authors, e.g., for the author profiles 118. The GUI 300 includes a variety of menus and/or fields that can receive user input to provide and configure author profiles.

For example, the GUI 300 includes an author name field 302, which is configured to receive input of an author name. For instance, a user can create a new author profile and/or reconfigure an existing author profile by entering an author name into the author name field 302.

The GUI 300 further includes an author category field 304 that enables an author to be assigned to a particular author category, such as defined via the GUI 200 discussed above. For example, a user can enter text into the author category field 304 specifying a pre-defined author category. Alternatively or additionally, the author category field 304 can be implemented as a drop-down menu that includes multiple pre-defined selectable author categories.

An author accounts region 306 is also included, which lists social media accounts that are correlated with the author identified in the author name field 302. For instance, author accounts listed can include accounts with multiple different social media platforms that are linked to one particular user. In at least some embodiments, an entry for an author account is selectable to edit information for the specific author account, such as to delete and/or configure a particular author account.

Further included is an add account control 308, which is selectable add a new social media account to an author profile. A customize metrics control 310 is further illustrated, which enables various metrics and/or metrics weighting to be customized for a particular user. For instance, in a default implementation the metrics and weighting associated with a category specified in the author category field 304 (e.g., as configured via the GUI 200) can be used to calculate an influence score for an author.

According to various embodiments, selecting the customize metrics control 310 can enable metrics to be customized for a specific user. For instance, the GUI 200 can be presented in response to selection of the customize metrics control 310 such that a custom set of metrics and/or custom metrics weighting can be specified for a particular author profile.

Consider, for example, that a user selects the customize metrics control 310. In response, the GUI 200 can be presented pre-populated with the configuration settings for the Sports Participant author category. The user can then customize the category for the specific user, such as by adding metrics, deleting metrics, changing metrics weighting, and so forth. The customized metrics configuration can be saved for that particular author such that the author's influence score is calculated based on the customized metrics. Thus, embodiments may utilize default metrics configurations for a pre-defined author category, and/or metrics configurations that are customized for a specific author.

The GUI 300 further includes an apply control 312, which is selectable to apply the input provided to the GUI 300 to generate and/or configure an author profile. For instance, selecting the apply control 312 can cause an author profile to be stored in the author profiles 118 based on information input to the GUI 300. Further, metrics for an identified author can be tracked and an influence score can be calculated based on social media events that occur related to the author profile. The metrics, influence score, identifiers for the social media events, and so on, can be stored as part of the author's profile.

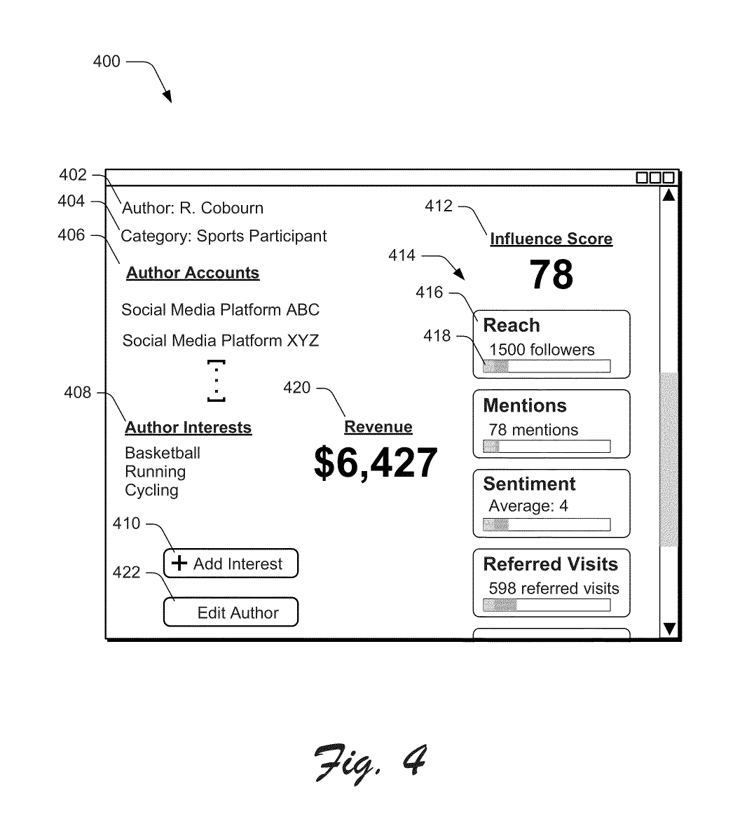

FIG. 4 illustrates an example graphical user interface (GUI) 400 that can be employed to view information about authors, such as based on author profiles that are generated and configured via the GUI 300, discussed above.

The GUI 400 includes an author identifier 402 which identifies an author for which information is being viewed, and an author category 404 for the author. An author accounts region 406 lists social media accounts that are linked to the author.

Further illustrated is an author interests region 408, which lists different interest categories that have been associated with the author. The author interests, for example, can be identified based on positive sentiment values provided by the author for particular topics. Other ways of identifying author interests may also be employed, such as identifying keywords in posts by an author, based on websites that an author visits and/or frequents, and so forth. An add interest control 410 is included, which enables interest categories to be added to the author interests region 408.

The GUI 400 further includes an influence score 412, which displays an influence score for the author as calculated according to techniques discussed herein. Beneath the influence score 412 is a metrics tracking region 414, which displays values for different metrics that are tracked for the author, e.g., as used to calculate the influence score 412. The metrics, for example, can be based on metrics for the author category and/or a custom metrics profile for the author.

For example, the metrics tracking region 414 includes a reach metric 416 (as described above) which quantifies a reach value for the author. The reach metric 414 indicates that the author has 1500 identified followers in the author's collection of social media accounts. A metric indicator 418 provides a visual indication of the contribution of the reach metric 416 to the influence score 412. For instance, the metric indicator 418 can be implemented as a progress bar that represents the total influence score. The shaded region of the metric indicator 418 indicates a relative percentage of the influence score represented by the value for the reach metric 414.

The metrics tracking region 414 includes other metrics that are tracked for the author, as well as values for the respective metrics. The illustrated metrics are presented for purpose of example only, and a variety of different types and combinations of metrics can be tracked in accordance with various embodiments.

Further illustrated is a revenue indicator 420, which specifies an amount of revenue that can be attributed to an author. The revenue indicator 420 can be calculated in various ways, such as based on purchases by other users that can be attributed to a direct and/or indirect recommendation by an author, e.g., Referred Purchases. In at least some embodiments, calculating a value for the revenue indicator 420 can include purchases by an author themself.

The GUI 400 further includes an edit control 422, which is selectable to enable various parameters for an author profile to be edited. For example, selecting the edit control 422 can cause the GUI 300 to be presented such that various author-related parameters can be configured.

Thus, the various GUIs discussed above can be employed to perform various techniques discussed herein, such as to configure algorithms for calculating influence scores, configure author profiles, and view information about different authors. The illustrated implementations and configurations of the GUIs discussed above are presented for purpose of example only, and it to be appreciated that a wide variety of different visual and/or functional configurations can be employed in accordance with various embodiments.

Having discussed some example GUIs, consider now a discussion of some example procedures in accordance with one or more embodiments.

Example Procedures

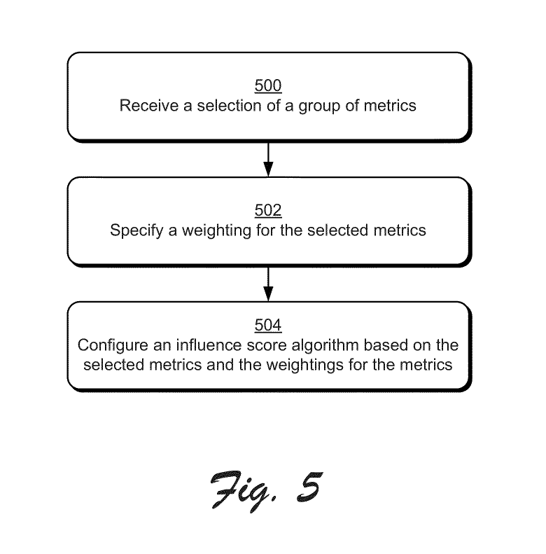

FIG. 5 is a flow diagram that describes steps in a method in accordance with one or more embodiments. The method, for instance, describes an example way of generating and/or configuring an influence score algorithm in accordance with various embodiments. In at least some implementations, aspects of the method can be implemented via the GUI 200 discussed above.

Step 500 receives a selection of a group of metrics. The metrics, for instance, can represent a set or subset of selectable metrics that are selected via user input. Examples of different metrics are discussed above.

While embodiments enable metrics to be individually selectable, at least some embodiments can provide different pre-configured groups of metrics that can be selected as a group. For instance, different categories of authors can be pre-defined and associated with different collections of metrics. A “sports participant” author category, for example, can have a different default set of metrics than a “political observer” author category. Thus, a user can select an author category and can be presented with its default set of metrics. The user can accept the default set of metrics, or can customize the default set of metrics by adding and/or deleting metrics from the default set of metrics.

Step 502 specifies weighting values for the selected metrics. For instance, a user can provide input indicating a weighting value for some or all of the metrics. Alternatively or additionally, individual metrics can have a default weighting value. For instance, in at least some embodiments a user can override a default metric weighting by providing input changing the weighting.

Further, some metrics may have a higher default weighting than others, such as metrics that are considered to be more indicative of social media influence than others. For instance, the Referred Purchases metric may be weighted higher by default than the Reach metric in calculating an influence score.

In at least some embodiments, an author category with a default set of metrics can have a default weighting for each of the metrics that a user can accept or customize.

Step 504 configures an influence score algorithm based on the selected metrics and the weightings for the metrics. An influence score algorithm can be associated with a particular category, such as an author category. Thus, in at least some embodiments, different author categories can be different collections of metrics and/or weighting values for respective metrics.

FIG. 6 is a flow diagram that describes steps in a method in accordance with one or more embodiments. The method, for instance, describes an example way of generating and/or configuring an author profile in accordance with various embodiments. In at least some implementations, aspects of the method can be implemented via the GUI 300 discussed above.

Step 600 identifies an author. A user, for instance, can input a name of an author. Alternatively or additionally, an author name can be selected, such as from a pre-configured group of author names.

Step 602 specifies a category for the author. A “default author” category, for example, can be automatically applied to the author. A user can override the default author category, such as by selecting a different author category.

Step 604 associates user accounts with the author. For instance, different accounts with different social media platforms can be linked to the author. As referenced above, the different accounts represent an author's presence in different social media platforms. In at least some embodiments, an author profile can be configured and reconfigured, such as by adding user accounts, deleting user accounts, and so forth, from the author's profile.

According to one or more embodiments, user accounts can be associated with an author in various ways. For instance, a user can input usernames and/or other user identifiers that correspond to accounts with different social media platforms.

Step 606 specifies a set of metrics for the author. The metrics, for example, can be automatically specified based on an author category specified for the author. Additionally or alternatively, a custom set of metrics can be selected, such as by customizing a default set of metrics (e.g., as presented based on author category), by selecting metrics from a group of selectable metrics, and so forth.

Step 608 weights the metrics. For instance, default weighting values can be automatically applied to the individual metrics, as discussed above. Alternatively or additionally, weighting values can be input by a user for different metrics.

Step 610 stores a profile for the author. The different attributes described above can be stored as part of the author's profile, e.g., the author's name, category, user accounts, metrics, metric weightings, and so forth. The author's profile can be stored as part of the author profiles 118 discussed above with reference to the environment 100. The author's profile can be activated such that monitoring and logging of social media activity of the author can be initiated. For instance, consider the following example procedure.

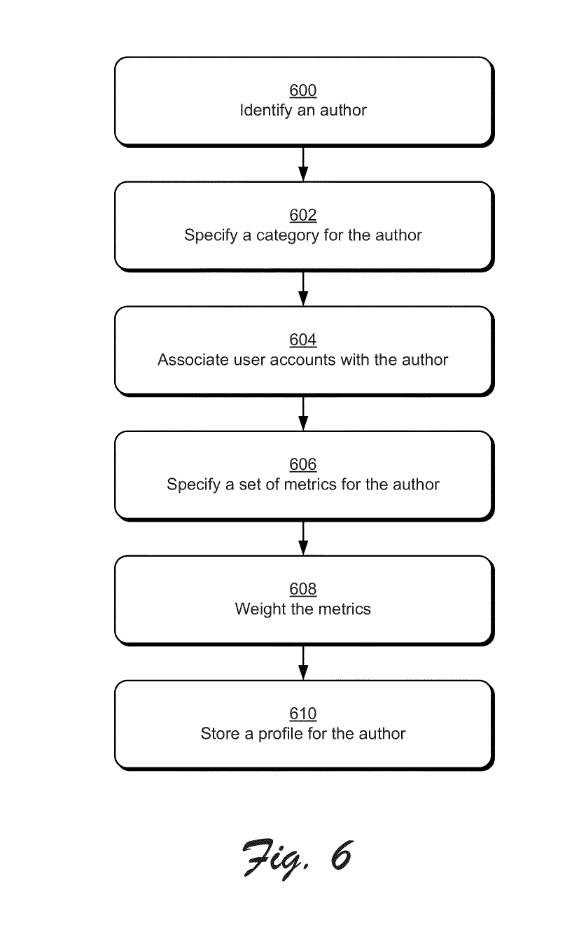

FIG. 7 is a flow diagram that describes steps in a method in accordance with one or more embodiments. The method, for instance, describes an example way of calculating an influence score for an author in accordance with various embodiments.

Step 700 receives metric values for an author. As discussed above, an author can be assigned a set of metrics, such as determined by an author category and/or as a custom set of metrics defined for the author. Each of the author's metrics can have a particular value, such as determined by events that correspond to the independent metrics and that affect metric values. Further details concerning metric values are discussed below.

Step 702 calculates an influence score for the author based on the metric values. For instance, values for each of the metrics can be added to obtain a total influence score. As discussed above, different metrics may have different weights that are applied to the values for the metrics to determine a contribution that each metric makes to a total influence score.

Step 704 outputs the influence score. The influence score, for example, can be output as part of a GUI, such as the GUI 400 discussed above with reference to FIG. 4.

Step 706 performs a task based on the influence score. For instance, authors with a high influence score in a particular author category can be included in product promotions for products that are correlated to the author category.

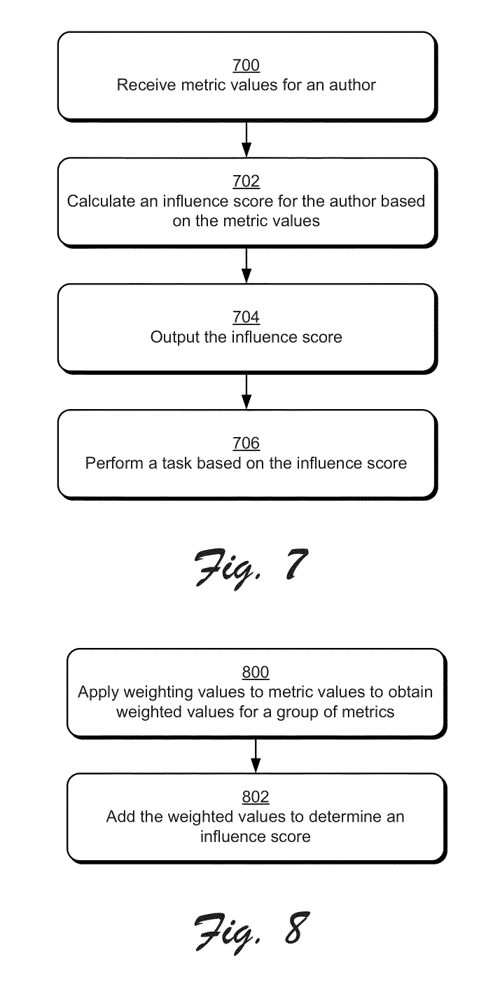

FIG. 8 is a flow diagram that describes steps in a method in accordance with one or more embodiments. The method, for instance, describes an example way of applying weighting to metric values as part of calculating an influence score. The method, for example, describes an example implementation of step 702 of FIG. 7, discussed above.

Step 800 applies weighting values to metric values to obtain weighted values for a group of metrics. The group of metrics, for instance, can be associated with a particular author profile. The weighting values can include default weighting values specified for individual metrics, and/or custom weighting values for individual metrics.

In at least some embodiments, a weighting value can be applied to a raw metric value to obtain a weighted value for the metric. For instance, consider the metrics listed in the GUI 400 discussed with reference to FIG. 4. The Reach metric has a raw value of 1500. Consider further that the Reach metric has a weighting value of 0.01, such as illustrated with reference to the GUI 200 of FIG. 2. To calculate a weighted value, the raw value of 1500 is multiplied by the weighting value of 0.01 to obtain a weighted Reach value of 15. Similarly, other raw metric values can be multiplied by their respective weighting values to obtain respective weighted metric values. This example technique for determining weighted values is presented for purpose of example only, and it is to be appreciated that different weighting techniques can be employed in accordance with various embodiments.

Step 802 adds the weighted values to determine an influence score. The different weighted values, for example, can be added together to indicate an influence score for an author.

In at least some embodiments, an influence score can be updated based on changes to metric values. For instance, consider the following example method.

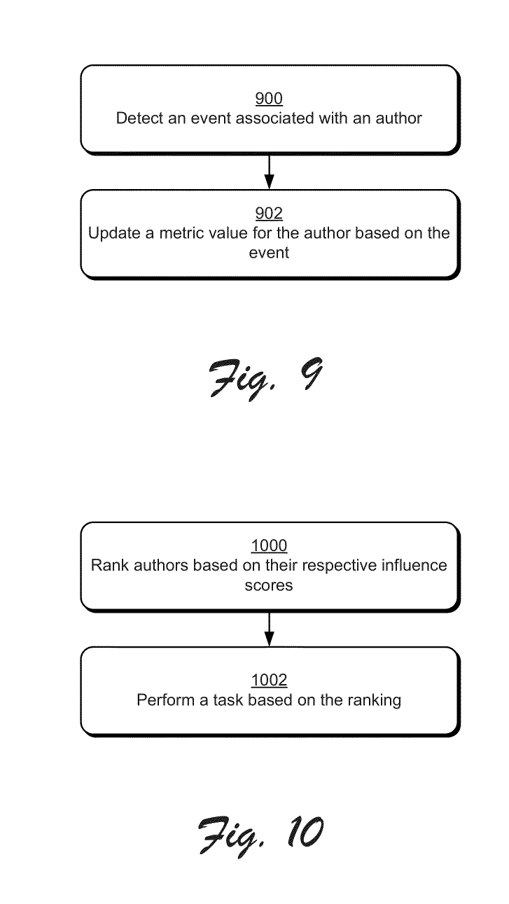

FIG. 9 is a flow diagram that describes steps in a method in accordance with one or more embodiments. In at least some embodiments, the method describes an example implementation of aspects of the methods discussed above, such as part of step 700 of FIG. 7 and/or step 800 of FIG. 8.

Step 900 detects an event associated with an author. The event, for example, corresponds to an event that occurs in and/or originates from a social media platform, and that can be linked to a particular author. Examples of events include:

(1) A change (e.g., an addition or subtraction) in a number of followers, fans, friends, and so forth, for an author in a social media platform. As referenced above, this corresponds to the “Reach” of an author in an overall social media environment.

(2) A change in Sentiment value for an author. For instance, if a user demonstrates an affinity for an author (e.g., “likes” the author in a social media platform), this can increase the author's sentiment value. A user can also provide a quantitative sentiment value for an author. For instance, a positive sentiment value (e.g., +1, +2, and so forth) indicates a positive affinity for an author, while a negative sentiment value (e.g., −1, −2, and so forth) indicates a negative sentiment towards an author.

(3) A Mention of an author in a social media platform and/or other online venue, such as a website. For instance, a user can provide a link to an author's page on a particular social media platform. As another example, textual analysis of a user's social media page can identify text that references an author.

(4) A visit to a webpage that originates from an author's social media page, e.g., a “Referred Visit.” For instance, an author can post a link to a particular website to their social media page. When another user selects the link and visits the website, the visit can be attributed as being referred by the author.

(5) A purchase by a different user that is attributed to a referral and/or recommendation by an author, e.g., a “Referred Purchase.” For example, if a user makes a purchase as part of a referred visit, the purchase can be attributed as being referred by an author.

(6) A registration by a different user that is attributed to a referral and/or recommendation by an author, e.g., a “Referred Registration.” For example, if a user registers (e.g., creates a user account) as part of a referred visit, the registration can be attributed as being referred by an author.

In at least some embodiments, events can be detected and/or reported in various ways, such as via the social data agent 114 discussed with reference to the environment 100. The events described above are presented for purpose of example only, and it is to be appreciated that a wide variety of other events can be defined and detected in accordance with various embodiments.

Step 902 updates a metric value for the author based on the event. The event, for example, is correlated to a metric or metrics defined for the author's profile, as discussed above. For instance, a referred visit attributed to the author increases a Referred Visit metric value, e.g., by one. An addition of a friend, follower, and/or fan increases a Reach metric, e.g., by one. A loss of a friend, follower, and/or fan decreases a Reach metric, e.g., by one. Thus, a detected event can increase or decrease a corresponding metric value.

In at least some embodiments, an event causes a change in a raw metric value for a corresponding metric. As detailed above, a weighting value can be applied to the raw metric value to obtain a weighted metric value that is used to calculate an influence score.

Step 904 recalculates an influence score based on the updated metric value. For instance, an influence score that was previously calculated can be recalculated to incorporate the updated metric value. Thus, in at least some embodiments an influence score can be dynamically updated in real time to reflect real time changes in metric values. For instance, as events that correspond to particular metrics occur, values for the metrics can be updated, weighting values applied to the updated metrics, and an influence score recalculated to determine an updated influence score. Metric values can increase and decrease, and thus influence scores may increase and decrease when recalculated. Output of the influence score can also be updated, such as in the GUI 400 discussed above.

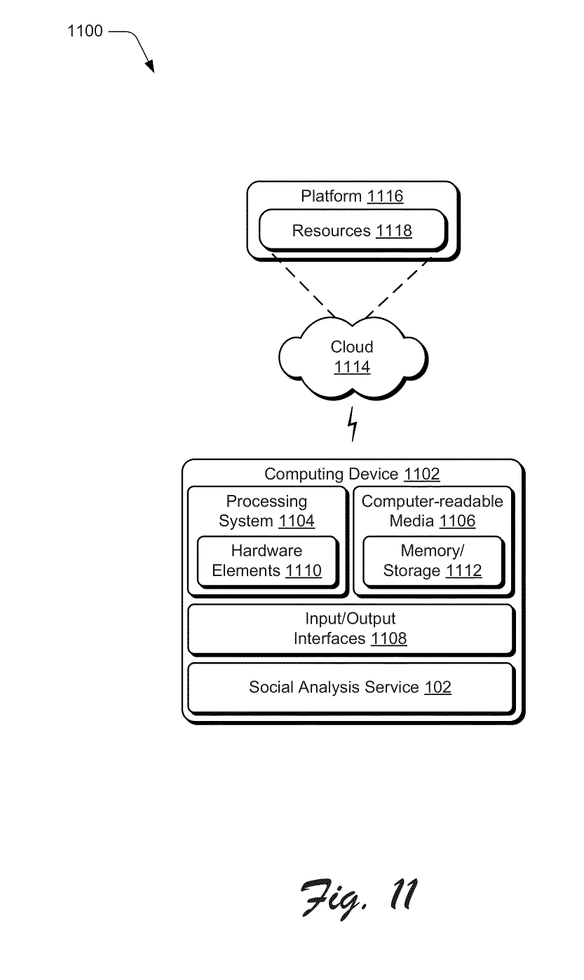

FIG. 10 is a flow diagram that describes steps in a method in accordance with one or more embodiments. In at least some embodiments, the method describes an example utilization of influence scores, such as for performing a task as referenced in step 706 of FIG. 7.

Step 1000 ranks authors based on their respective influence scores. For instance, a group of authors can be ranked such that authors with higher influence scores are ranked higher than authors with lower influence scores. Thus, in at least some embodiments, the higher an author's influence score, the higher the author is ranked.

According to one or more embodiments, authors can be ranked by their influence scores in different author categories. Thus, different author categories can have different collections of authors and different author rankings. A particular author, for instance, can be ranked in a single author category, and/or in multiple author categories. Further, a particular author may have a different ranking in one author category than in another author category.

According to one or more embodiments, authors can be ranked based on their attributed revenue, such as discussed above with reference to FIG. 4. For example, as an addition or an alternative to ranking by influence scores, authors can be ranked by attributed revenue.

Step 1002 performs a task based on the ranking. For example, a threshold influence score can be pre-specified. The threshold influence score, for instance, can be specified as the average influence score for a group of authors. A threshold influence score may also be specified as an arbitrary influence score, e.g., a positive value such as 75. Authors that meet or exceed the threshold influence score can be flagged as “influencers” that have demonstrated influence on various aspects of social media. Authors that do not meet or exceed the threshold influence score can be excluded from the group of influencers.

In embodiments that rank authors based on attributed revenue, a threshold revenue value can be specified. The threshold revenue value, for instance, can be specified as an average revenue value for a group of authors. A threshold revenue value may also be specified as an arbitrary revenue value, e.g., $5,000. Authors that meet or exceed the threshold revenue value can be flagged as “influencers” that have demonstrated influence on various aspects of social media. Authors that do not meet or exceed the threshold revenue value can be excluded from the group of influencers.

Once a group of influencers has been identified, the author profiles of the influencers can be used in various ways. For instance, marketing campaigns can be focused on influencers and/or their followers, such as for products and/or services targeted to an author group. An author group, for instance, can correspond to a marketing demographic for purposes of marketing different products and/or services to authors in the author group and/or their friends, fans, and/or followers.

In at least some embodiments, a ranking of authors can be utilized to implement a graduated promotion campaign for products and/or services. For instance, more promotion resources can be dedicated to promoting a product and/or resource to higher ranked authors. As author ranking decreases, the amount of promotion resources dedicated to promoting the corresponding authors can be decreased.

Having discussed some example procedures, consider now a discussion of an example system and device in accordance with one or more embodiments.

Example System and Device

FIG. 11 illustrates an example system generally at 1100 that includes an example computing device 1102 that is representative of one or more computing systems and/or devices that may implement the various techniques described herein. This is illustrated through inclusion of the social analysis service 102, which may be employed to implement techniques for influence scoring for social media authors discussed herein. The computing device 1102 may be, for example, a server of a service provider, a device associated with a client (e.g., a client device), an on-chip system, and/or any other suitable computing device or computing system.

The computing device 1102 as illustrated includes a processing system 1104, one or more computer-readable media 1106, and one or more I/O interfaces 1108 that are communicatively coupled and/or connected, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware elements 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 are illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” refer to media and/or devices that enable persistent storage of information in contrast to mere signal transmission, carrier waves, or signals per se. Thus, computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of the computing device 1102 and are not limited to the specific examples of the techniques described herein. This functionality may also be implemented all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 may include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 may abstract resources and functions to connect the computing device 1102 with other computing devices. The platform 1116 may also serve to abstract scaling of resources to provide a corresponding level of scale to encountered demand for the resources 1118 that are implemented via the platform 1116. Accordingly, in an interconnected device embodiment, implementation of functionality described herein may be distributed throughout the system 1100. For example, the functionality may be implemented in part on the computing device 1102 as well as via the platform 1116 that abstracts the functionality of the cloud 1114.

Discussed herein are a number of methods that may be implemented to perform techniques discussed herein. Aspects of the methods may be implemented in hardware, firmware, or software, or a combination thereof. The methods are shown as a set of blocks (e.g., steps) that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100, the system 1100, and so on.

Conclusion

Techniques for influence scoring for social media authors are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
one or more processors; and
one or more computer-readable storage media storing computer-executable instructions that, responsive to execution by the one or more processors, cause the system to perform operations including:
receiving metric values for a group of metrics specified for a social media author, one or more of the metrics corresponding to an action by a user other than the social media author that is attributed to a referral by the social media author; and
calculating an influence score for the social media author by applying a weighting value to one of more of the metric values and adding the metric values to obtain a total influence score.

2. A system as described in claim 1, wherein the metric values correspond to a number of occurrences of specific events associated with one or more social media platforms.

3. A system as described in claim 1, wherein the metrics include one or more of a reach parameter for the author, a mentions parameter for the author, or a sentiment parameter for the author.

4. A system as described in claim 1, wherein the action by the user other than the social media author comprises one or more of a referred visit to a website, a referred registration, or a referred purchase.

5. A system as described in claim 1, wherein the operations include:
detecting an event associated with the social media author;
updating one or more of the metric values for the group of metrics based on the event; and
recalculating the influence score based on the updated one or more metric values.

6. A system as described in claim 1, wherein the operations include:
ranking the social media author along with a group of other social media authors based on their respective influence scores; and
performing a task based on said ranking.

7. A system as described in claim 6, wherein the social media author and the group of other social media authors are classified in a specific category of social media authors, and wherein said ranking ranks the social media authors within the specific category.

8. A system as described in claim 1, wherein the operations include outputting a graphical user interface (GUI) that displays the influence score and indicia of the metric values for the group of metrics.

9. A system as described in claim 1, wherein the operations include:
receiving user input reconfiguring one or more metrics of the group of metrics; and
recalculating the influence score based on the one or more reconfigured metrics.

10. A computer-implemented method, comprising:
specifying a set of metrics for a social media author;
weighting individual metrics of the set of metrics; and
storing a profile for the social media author such that the profile is usable to calculate an influence score for the social media author based on events the affect individual metrics of the set of metrics, and weighting values specified for the individual metrics.

11. A computer-implemented method as recited in claim 10, wherein one or more of the metrics correspond to an action by a user other than the social media author that is attributed to a referral by the social media author.

12. A computer-implemented method as recited in claim 10, wherein said specifying and said weighting are implemented via input to a graphical user interface (GUI) that enables various social media parameters for the social media author to be configured.

13. A computer-implemented method as recited in claim 10, comprising:
specifying an author category for categorizing the social media author; and
storing the author category as part of the profile for the social media author.

14. A computer-implemented method as recited in claim 10, wherein said specifying comprises selecting a pre-configured author category for the social media author, the pre-configured author category including the set of metrics by default.

15. A computer-implemented method as recited in claim 14, wherein said weighting comprises applying default weighting values for the pre-configured author category to the set of metrics, the default weighting values being user-configurable.

16. One or more computer-readable storage media having instructions stored thereon that, responsive to execution by one or more processors, cause the one or more processors to perform operations comprising:
receiving a selection of a group of metrics to be used to track social media events;
specifying weighting values for individual metrics of the group of metrics; and
configuring an influence score algorithm based on the selected metrics and the weighting values for the individual metrics.

17. One or more computer-readable storage media as recited in claim 16, wherein the group of metrics includes one or more of a referred visit to a website, a referred registration, or a referred purchase.

18. One or more computer-readable storage media as recited in claim 16, wherein the operations comprise specifying an author category for the influence score algorithm such that an influence score for a social media author is calculated via the influence score algorithm by categorizing the social media author in the author category.

19. One or more computer-readable storage media as recited in claim 16, wherein the operations comprise specifying the weighting values via user input that specifies different weighting values for different metrics of the group of metrics.

20. One or more computer-readable storage media as recited in claim 16, wherein the operations comprise:
receiving metric values for a social media author and for at least some of the metrics of the group of metrics; and
applying the metric values to the influence score algorithm to calculate an influence score for the social media author.
